(19) United States
(12) Patent Application Publication
(10) Pub. No.: US 2004/0108750 A1
(43) Pub. Date: Jun. 10, 2004

(54) Folding camp container

(76) Inventor: Yong Soon Park, Andong City (KR)

Correspondence Address: LADAS & PARRY, 224 SOUTH MICHIGAN AVENUE, SUITE 1200, CHICAGO, IL, 60604, US

(21) Appl. No.: 10/706,750

(22) Filed: Nov. 12, 2003

(30) Foreign Application Priority Data
Dec. 4, 2002 (KR) 20-2002-0036262

(51) Int. Cl. B60P 3/34

(52) U.S. Cl. 296/156

(57) ABSTRACT

A folding camp container is a vehicle-mounted hexahedral container including panels constituting the bottom and ceiling of the container and left and right side panels combined with the bottom and ceiling panels, in which at least one of the left and right side panels includes two or more divided panels which are extended horizontally and telescopically from the container. Each divided panel is combined with an adjacent panel in an unfolding structure by hinges, in which any one of the bottom and ceiling of the container is extended when the container is unfolded. One or more partitioning panels are combined with the side surface of the upper or lower surface of the unfolded divided panel in a folding and hinge structure, in which side walls extending the front and rear side panels of the container or partitioning the inner space thereof are formed when the container is unfolded. The divided panels are fixed on panels installed perpendicularly with the corresponding panels by cylinder-shaped connection rods. Thus, the folding camp container is used as a general cargo transportation container during transportation, and is used as a camp container having a wide inner room by unfolding the panels combined with one another by a folding hinge structure during camping.

### BACKGROUND OF THE INVENTION

1. Field of the Invention

The present invention relates to a folding camp container, and more particularly, to a folding camp container having an inner space extension function by a folding structure and accommodating facilities required in an outdoor activity.

2. Description of the Related Art

In general, a container box is mainly used for transportation of goods. Recently, such a container box is modified into and used as an office or residence facility. The container box is fabricated into an appropriate shape or size according to the purpose of use, and contrived for conveniences of users.

As described above, a conventional container has various accommodating facilities therein. However, the conventional container is provided in simple structure in which accommodating facilities such as a bed and a kitchen sink are formed in the inner space thereof at the state where a structure of extending an inner space is not demanded strongly. As a result, limitation of the inner space in the conventional container has not been overcome.

Also, in order to use a container having the accommodating facilities as cargo transportation, the accommodating facilities installed in the container should be dismantled artificially. Accordingly, the container having the accommodating facilities cannot be used conveniently as cargo transportation.

Meanwhile, in Korean Patent Publication No. 0153278 entitled “Container-shaped Movable Structure” and Korean Utility Model Publication No. 188253 entitled: Multi-functional Container Box,” as shown in FIGS. 1 and 2, a separate inner structure body called an auxiliary box is provided in an outer structure body called a main box. Accordingly, when space extension is needed in the container, the inner structure body installed in the outer structure body is moved slidably by guide rails, to thereby extend an inner space of the container.

However, although the above-described containers have an advantage in view of extension of the inner space to a degree, both the outer structure body and the inner structure body which form the container box are very heavy to thereby consume much fuel during transportation.

Also, since an excessive distance is spaced between the inner structure body and the outer structure body when the inner space is extended, a stress concentration phenomenon occurs according to a moment to thereby impose a fatigue load on the frame body of a vehicle.

Also, a vehicle is slanted with deflection due to the stress concentration phenomenon, the accommodating facilities installed in the container do not maintain the horizon. accordingly, users cannot use the accommodating facilities installed in the container efficiently.

### SUMMARY OF THE INVENTION

To solve the above problems, it is an object of the present invention to provide a folding camp container which does not impose an excessive fatigue load on a vehicle, and has an inner space extension function by employing a folding structure.

It is another object of the present invention to provide a folding camp container having a variety of accommodating facilities required for an outdoor activity.

To accomplish the above object of the present invention, there is provided a folding camp container which is a vehicle-mounted hexahedral container including panels constituting the bottom and ceiling of the container and left and right side panels combined with the bottom and ceiling panels, the folding camp container comprising: at least one of the left and right side panels comprising two or more divided panels which are extended horizontally and telescopically from the container, wherein each divided panel is combined with an adjacent panel in an unfolding structure by hinges, in which any one of the bottom and ceiling of the container is extended when the container is unfolded; and one or more partitioning panels combined with the side surface of the upper or lower surface of the unfolded divided panel in a folding and hinge structure, in which side walls extending the front and rear side panels of the container or partitioning the inner space thereof are formed when the container is unfolded, wherein the divided panels are fixed on panels installed perpendicularly with the corresponding panels by cylinder-shaped connection rods.

Preferably, a winding roller is provided in the end of the divided panel combined with the ceiling panel, and a winding member such as a blind screen, a wind preventive screen, a shield, or an insect-proof screen is provided so as to be wound by the winding roller, to thereby form a protective wall for substitution of an outer wall.

### BRIEF DESCRIPTION OF THE DRAWINGS

The above and other objects and advantages of the present invention will become more apparent by describing the preferred embodiment thereof in more detail with reference to the accompanying drawings in which:

FIG. 1 is a perspective view showing a conventional container-shaped movable structure having a space extension function by a sliding structure;

FIG. 2 a perspective view showing a conventional container-shaped box having a space extension function by a sliding structure;

FIG. 3 a perspective view showing the whole structure of a folding camp container according to the present invention;

FIG. 4 is a cross-sectional view showing a fixing structure of a divided panel in a folding camp container according to the present invention;

FIG. 5 is a perspective view showing a folding camp container having a winding roller installed in the end of each divided panel according to the present invention;

FIG. 6 is a perspective view showing a folding camp container having a water supply facility and a cooking facility with a water tank according to an embodiment of the present invention;

FIG. 7 is a perspective view showing a structure of a lavatory provided in a folding camp container according to the present invention;

FIG. 8 is a cross-sectional view showing a structure of a septic tank provided in a folding camp container according to the present invention; and

FIG. 9 is a cross-sectional view showing a sleeping facility in a folding camp container according to the present invention.

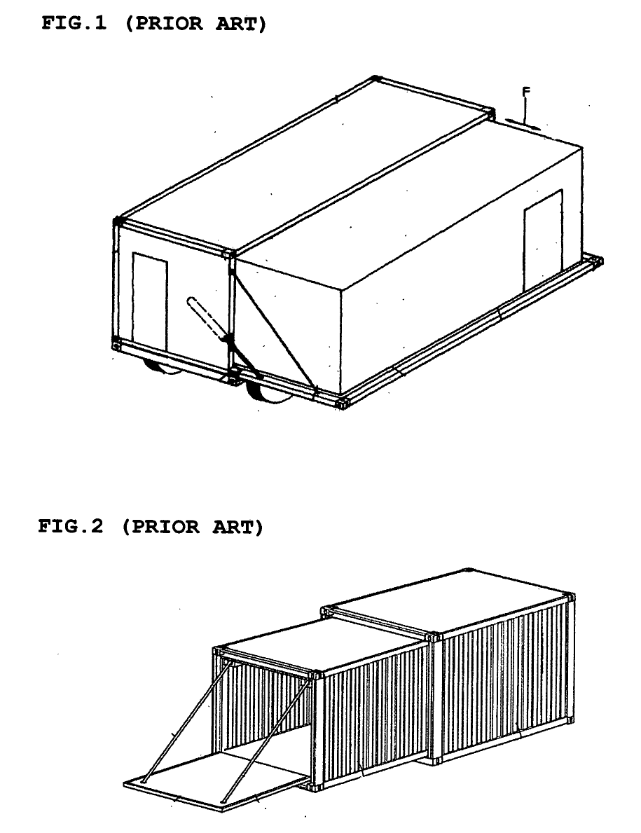

### DETAILED DESCRIPTION OF THE INVENTION

A folding camp container according to a preferred embodiment of the present invention will be described with reference to the accompanying drawings.

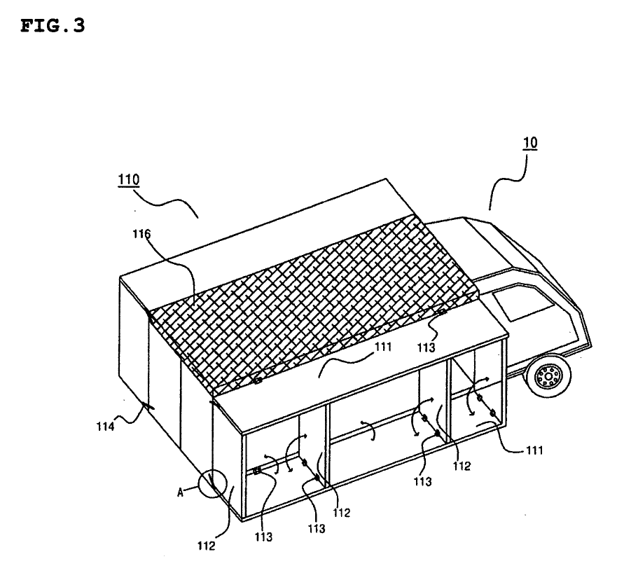

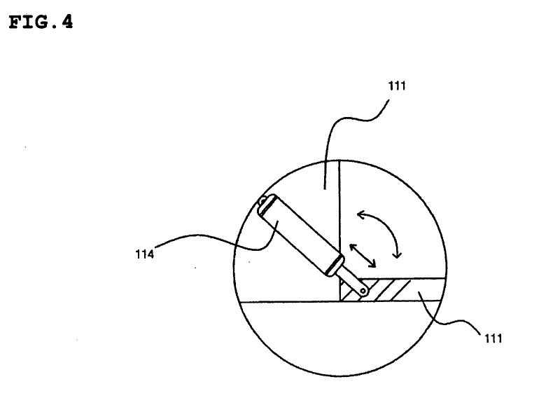

Referring to FIGS. 3 through 4, a basic structure of a folding camp container according to the present invention will be described below in detail.

In general, a folding camp container is divided into a fixed type which is used for an office or residence space, and a movable type which is used for an outdoor activity such as a camping in the form of a trailer vehicle mounted with a container. The present invention can be applied in both cases. However, the folding camp container according to the present invention is more effective when it is fixed on a vehicle 10.

As shown in FIGS. 3 and 4, the folding camp container 100 according to a preferred embodiment of the present invention is embodied into a general container 110 having panels 111 on the hexahedral planes. In the present invention, at least one of the hexahedral panels 111 is divided. The divided panel 111 is combined with an adjacent panel by a hinge structure 113, so that the extended panel 111 is extended externally.

Also, in the present invention, the divided panel 111 is extended not to form a simple planar space but form a three-dimensional space. For this purpose, a partitioning panel 112 is combined with the upper or lower end of the divided panel 111 by a hinge structure, to thereby form a predetermined three-dimensional space.

Here, the predetermined spaces formed by the divided panels 111 and the partitioning panels 112 are preferably provided with a balance in the container box 110 in view of the structure of the container 110, so that an eccentric load due to a moment is located at the center of a vehicle 10.

Also, in order to prevent the eccentric loads which occurs when the divided panels 111 are extended from being centered on the hinges 13 which are not strong to external stresses, the divided panel 111 and the adjacent panels 111 are reinforced and combined with each other by cylinder-shaped connection rods 114 in the present invention. Accordingly, the eccentric load imposed on the hinges 113 are distributed.

In this manner, a user can use the folding camp container according to the present invention, by folding or unfolding the divided panels 111 and the partitioning panels 112 according to the use such as cargo transportation or provision of accommodating facilities for outdoor activity.

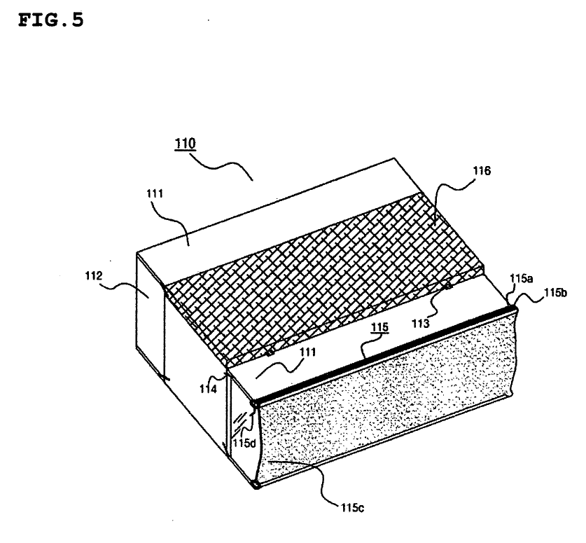

Meanwhile, as shown in FIG. 5, according to a preferred embodiment of the present invention, a winding roller 115 is provided in the end of the divided panel 111 which forms the upper portion of the divided panel 111, that is, the extension plane of the ceiling panel, to thereby enable a winding member 115c such as a blind screen, a wind preventive screen, a shield, or an insect-proof screen to be provided so as to be wound by the winding roller, to thereby form a protective wall for substitution of an outer wall. The end of the winding member 115c is fixed to the lower divided panel 111 or the winding member 115c is wound around the rod so as to be fixed by the whole weight of the rod.

Here, the winding roller 115 includes the winding member 115c, a cylindrical hollow tube 115a forming a housing of winding roller, and a winding axis 115b installed in the hollow tube 115a, for winding the winding member 115b.

As shown in FIG. 5, a steering handle 115d is provided in the end of the winding axis 115b as a driving unit of the winding roller 115. Otherwise, although it has not shown in the drawings, an electric actuator is provided as a driving unit of the winding roller 115, in order to wind the winding member.

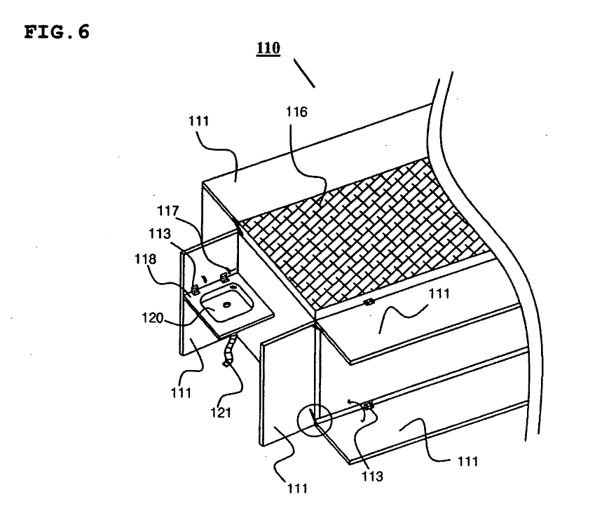

Meanwhile, as shown in FIGS. 6 through 9, the present invention provides a folding camp container having accommodating facilities such as a water supply facility, a cooking facility, a sleeping facility, and a lavatory so that users perform outdoor activities more efficiently.

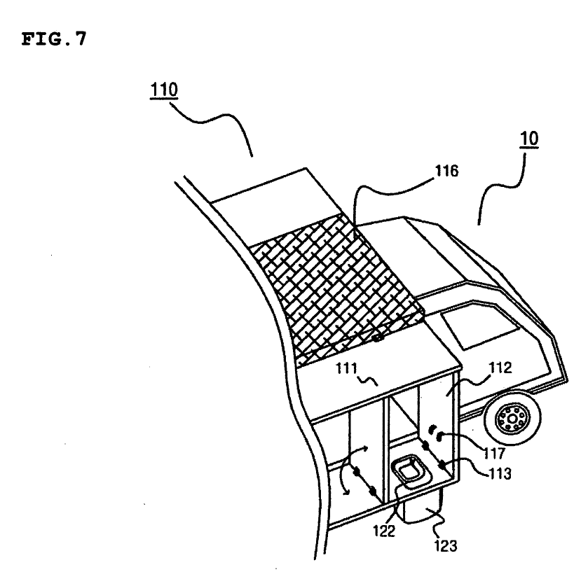

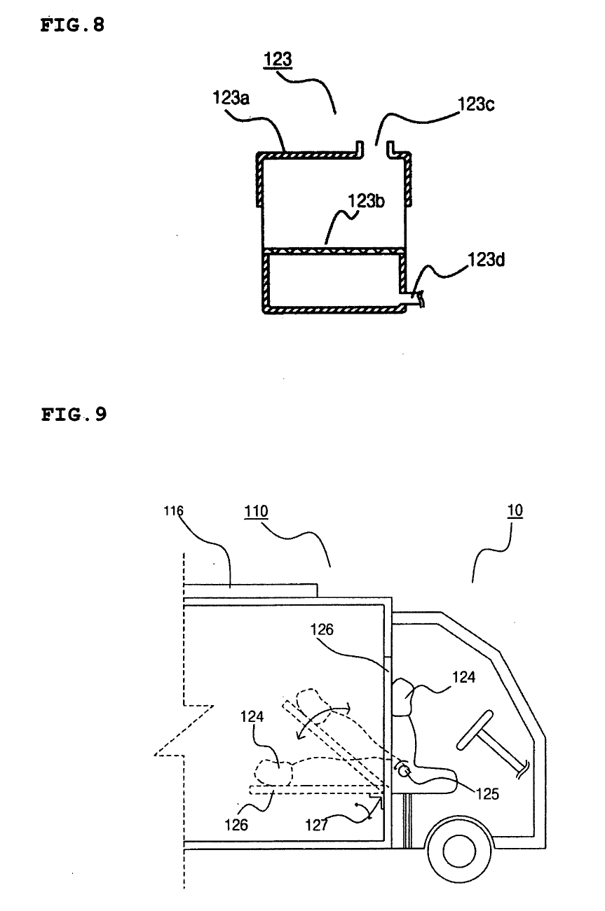

FIG. 6 is a perspective view showing a folding camp container having a water supply facility and a cooking facility with a water tank according to an embodiment of the present invention. FIG. 7 is a perspective view showing a structure of a lavatory provided in a folding camp container according to the present invention. FIG. 8 is a cross-sectional view showing a structure of a septic tank provided in a folding camp container according to the present invention. FIG. 9 is a cross-sectional view showing a sleeping facility in a folding camp container according to the present invention. The accommodating facilities provided in a folding camp container according to the present invention will be described below with reference to FIGS. 6 through 9.

As shown in FIG. 6, a water supply facility provided in a folding camp container 110 according to the present invention includes a water tank 116 in the upper portion of the container 110, and one or more water taps 117 connected with the water tank 116 via a water supply tube (not shown) in the container 110.

Here, the water taps 117 are installed in places where the water taps 117 are used such as a cooking facility and a lavatory, irrespective of the number and place.

As shown in FIG. 6, a cooking facility provided in a folding camp container 110 according to the present invention is installed in an entrance gate thereof, in which an auxiliary panel 118 at the center of which an insertion hole (not shown) is formed is combined at a predetermined height by hinges 113 so that an assembly sink 120 can be attachably or detachably formed.

Here, a drain sewage 121 for the sink 120 installed in the auxiliary panel 118 is combined with a septic tank 123 to be described later, in order to purify polluted water produced from the cooking or washing and discharge the purified water externally.

Thus, when a user desires to use a cooking facility therein, he or she unfolds the auxiliary panel 118 combined with the hinges 113 and mounts the sink 120 thereon, so as to be used as a cooking facility.

Also, when a predetermined space is needed to cook, an auxiliary panel 118 having no insertion hole through which a sink 120 is inserted is provided on the other side of the divided panel 111, in the substantially same structure as that of the cooking facility, to thereby assume the predetermined space needed to cook.

Meanwhile, as shown in FIG. 7, a predetermined space separated from a main space is formed by the divided panels 111 and the partitioning panels 112 to be provided as a lavatory. In the lavatory space, an assembly excremental sanitary unit 114 is installed in the lavatory space to form a temporary toilet room. Here, a septic tank 123 is installed in the lower portion of the assembly excremental sanitary unit 122. Meanwhile, in order to install the assembly excremental sanitary unit 122, an insertion hole (not shown) into which the assembly excremental sanitary unit 122 is inserted is formed in the divided panel 111.

As shown in FIG. 8, the septic tank 123 includes a purifier 123b including a filtering screen or a purifying filter in the septic chamber 123a. It is preferable that an incoming hole 123c through which polluted water produced by the lavatory, cooling facility and other accommodating facilities is formed on the upper portion of the septic chamber 123a, and an outgoing hole 123d through which the sewage purified from the incoming polluted water by the purifier is discharged on the lower portion of the septic chamber 123a.

Since the above-described septic tank is provided, polluted water produced by the lavatory, cooling facility and other accommodating facilities is purified, to then be discharged externally and suppress an environmental pollution.

Meanwhile, a chair installed in a driver's seat of a general vehicle is bent by a rotating hinge 125 to be transformed into a sleeping bed. However, since an internal space in the driver's seat is narrow in the case of a vehicle having a container, the driver's chair 124 is not completely unfolded. As a result, the driver's chair 124 is not transformed into a comfortable bed.

In order to solve the above-described problem that the driver's chair 124 is not transformed into a comfortable bed, the present invention is designed to unfold the container 110 to a user's desired degree, as shown in FIG. 9.

For this purpose, a panel 126 contacting the driver's seat among the hexahedral panels forming the container 110 is divided into a number of panels by a hinge structure 127.

Thus, in the case that the driver's chair 124 is used as a bed according to a user's desire, the panel 126 combined by the hinges 127 is unfolded to the inner position of the container 110 to extend the inner space of the driver's seat. Here, the driver's chair 124 is completely unfolded by using a rotating hinge 125 to then be used as a bed.

As described above, the folding camp container according to the present invention has overcome the conventional limitation in extending the inner space of the container, and reduces stress concentration which occurs due to the excessive partial deflection which is formed between the inner structure body and the outer structure body during unfolding, to thereby solve the conventional problem caused by the stress concentration phenomenon.

Also, the conventional container can be modified into the folding camp container according to the present invention at low cost, to thus provide a generally expensive camping car at low cost.

As described above, the present invention has been described with respect to particularly preferred embodiments. However, the present invention is not limited to the above embodiments, and it is possible for one who has an ordinary skill in the art to make various modifications and variations, without departing off the spirit of the present invention.

What is claimed is:

1. A folding camp container which is a vehicle-mounted hexahedral container including panels constituting the bottom and ceiling of the container and left and right side panels combined with the bottom and ceiling panels, the folding camp container comprising:
at least one of the left and right side panels comprising two or more divided panels which are extended horizontally and telescopically from the container, wherein each divided panel is combined with an adjacent panel in an unfolding structure by hinges, in which any one of the bottom and ceiling of the container is extended when the container is unfolded; and
one or more partitioning panels combined with the side surface of the upper or lower surface of the unfolded divided panel in a folding and hinge structure, in which side walls extending the front and rear side panels of the container or partitioning the inner space thereof are formed when the container is unfolded,
wherein the divided panels are fixed on panels installed perpendicularly with the corresponding panels by cylinder-shaped connection rods.

2. The folding camp container of claim 1, wherein a winding roller is provided in the end of the divided panel combined with the ceiling panel, and a winding member such as a blind screen, a wind preventive screen, a shield, or an insect-proof screen is provided so as to be wound by the winding roller, to thereby form a protective wall for substitution of an outer wall.

3. The folding camp container of claim 1, wherein a water tank is provided in the upper portion of the ceiling panel of the container and one or more water taps connected with the water tank via a hose are provided therein.

4. The folding camp container of claim 2, wherein a water tank is provided in the upper portion of the ceiling panel of the container and one or more water taps connected with the water tank via a hose are provided therein.

5. The folding camp container of claim 1, wherein an auxiliary panel having an insertion hole through which a sink can be inserted is combined with the central portion of the inner side of the rear panel at a predetermined height by a folding hinge structure, so as to form a sink during unfolding and assembling the auxiliary panel.

6. The folding camp container of claim 2, wherein an auxiliary panel having an insertion hole through which a sink can be inserted is combined with the central portion of the inner side of the rear panel at a predetermined height by a folding hinge structure, so as to form a sink during unfolding and assembling the auxiliary panel.

7. The folding camp container of claim 1, wherein a predetermined space separated from a main space is formed by the divided panels and the partitioning panels so as to be provided as a lavatory, an assembly excremental sanitary unit is installed in the lavatory space to form a temporary toilet room, and a portable septic tank is installed in the lower portion of the assembly excremental sanitary unit, to thereby form a temporary assembly toilet.

8. The folding camp container of claim 2, wherein a predetermined space separated from a main space is formed by the divided panels and the partitioning panels so as to be provided as a lavatory, an assembly excremental sanitary unit is installed in the lavatory space to form a temporary toilet room, and a portable septic tank is installed in the lower portion of the assembly excremental sanitary unit, to thereby form a temporary assembly toilet.

9. The folding camp container of claim 1, wherein a panel contacting the driver's seat among the hexahedral panels forming the container is divided into a number of panels and the divided panels are combined with one another by a folding hinge structure, respectively, so as to form a predetermined space to unfold a driver's seat of a hinge structure.

10. The folding camp container of claim 2, wherein a panel contacting the driver's seat among the hexahedral panels forming the container is divided into a number of panels and the divided panels are combined with one another by a folding hinge structure, respectively, so as to form a predetermined space to unfold a driver's seat of a hinge structure.
